(19) United States
(12) Patent Application Publication
(10) Pub. No.: US 2015/0379450 A1
(43) Pub. Date: Dec. 31, 2015

(54) SUPPLY RULE GENERATING DEVICE AND SUPPLY RULE GENERATING PROGRAM

(71) Applicant: HITACHI, LTD., Chiyoda-ku, Tokyo (JP)

(72) Inventors: Tazu NOMOTO, Tokyo (JP); Junko HOSODA, Tokyo (JP)

(21) Appl. No.: 14/768,761

(22) PCT Filed: Feb. 20, 2013
(86) PCT No.: PCT/JP2013/054075

§ 371 Date: Aug. 18, 2015

(51) Int. Cl. G06Q 10/06; G06Q 10/08

(52) U.S. Cl. CPC G06Q 10/06315; G06Q 10/0875

(57) ABSTRACT

Provided are a device and method for providing means for enabling companies or business entities to supply one another with a finished product, a partly finished product, or a part. A supply rule generating device includes a storing unit and a processing unit, and calculates a supply rule, which is a condition for enabling two or more companies or business entities that procure or supply the same part or same product to accommodate one another with a part, a partly finished product, or a finished product. The processing unit is configured to: calculate a production plan and a stock plan for each of the two or more companies or business entities so that a shipment quantity stored in a shipment plan storing unit is fulfilled, based on information stored in a stock and in-progress storing unit and information stored in a production information storing unit; calculate, from the calculated production plan and stock plan, a surplus stock quantity of the company or business entity at each of a plurality of points in future time, and a time point at which the company or business entity needs to re-stock when the surplus stock quantity is supplied to another company or business entity; and calculate an accommodation quantity and accommodation condition of a part, a partly finished product, or a finished product that is suppliable to another company or business entity.

### TECHNICAL FIELD

The present invention relates to a device and method for enabling a plurality of companies or business entities to accommodate one another with a product or a part that is produced or traded by the companies or the business entities.

### BACKGROUND ART

A product for which markets are scattered over a plurality of regions/countries has storage bases or production bases close to the markets, and the stock replenishment or production of the product is conducted based on a demand projection or a sales plan. Fluctuations in demand are dealt with by reviewing stock replenishment or production each time the demand forecast or the sales plan changes, or regularly. However, fluctuations surpassing the expected scale due to a steep increase in demand, a supply difficulty from an earthquake disaster or political instability, or the like cannot be absorbed by efforts of one company alone, such as replenishing under a safety stock model and working overtime or on a day off, and could lead to a loss of opportunity or a delay in delivery. A loss of opportunity in such cases may be prevented by accommodating the company with surplus stock of the product in question at another company or business entity that carries the product, or by commissioning the other company or business entity to produce the product.

In Patent Literature 1, there is disclosed a method of assisting companies in trading a product with one another, where a buyer and a seller make an option contract regarding the range of projected demand and carry out the option. Examples of an option contract include one prescribing a maximum number for a type of product that the seller is obliged to supply, and one prescribing a minimum number for a type of product that the buyer is obliged to purchase. The buyer and the seller adjust the sales/purchase quantity within the range set forth in the contract.

### CITATION LIST

### Patent Literature

[PTL 1] Japanese Patent Laid-open Publication No. 2000-525761

### SUMMARY OF INVENTION

### Technical Problem

When demand and supply fluctuations are too large to be dealt with by one company alone and it is decided to ask another company to supply its surplus stock, the company first needs to find another company that has surplus stock. In the case where the other company is in another country, contacting the other company immediately may not be possible due to the time difference. The company that is asked to supply its stock, on the other hand, needs to find out how many pieces can be supplied without affecting its own business and a price at which the stock is to be sold. However, determining those takes time except when a clearly excessive quantity is in stock.

In the case of accommodation between production factories, it is better to identify the cause of shortage and determine whether a finished product is to be supplied or a partly finished product or some part is to be supplied in order to avoid excessive accommodation.

The option contract of Patent Literature 1 is made between a buyer and a seller with respect to a particular product and, as a general rule, is not changed frequently once the contract is in effect. In addition, determining what item is to be supplied from one party to another by taking into account the parts configuration is not simulated in the option contract.

The present invention has been made in view of those points, and it is a first object of the present invention to generate a supply rule, which includes a quantity of a product or a part that can be supplied from surplus stock at one company or business entity to another company or business entity, and a condition for the accommodation. It is a second object of the present invention to provide means for supplying a product or a part between companies or between business entities by following the supply rule.

### Solution to Problem

In order to attain the above-mentioned first object, according to one embodiment of the present invention, there is provided a supply rule generating device, including a storing unit and a processing unit, the supply rule generating device being configured to calculate a supply rule, which is a condition for enabling two or more companies or business entities that procure or supply the same part or same product to accommodate one another with a part, a partly finished product, or a finished product, in which the storing unit includes: an item configuration storing unit configured to store a configuration table of items including parts, partly finished products, or finished products; a stock and in-progress storing unit configured to store, for each item, a stock quantity and an in-progress quantity on a site-by-site basis; a product information storing unit configured to store, for each item, a production time and a cost on a site-by-site basis; and a shipment plan storing unit configured to store a shipment quantity of a product on a date-by-date basis and on a site-by-site basis, and in which the processing unit is configured to: calculate a production plan and a stock plan for each of the two or more companies or business entities so that the shipment quantity stored in the shipment plan storing unit is fulfilled, based on the information stored in the stock and in-progress storing unit and the information stored in the production information storing unit; calculate, from the calculated production plan and stock plan, a surplus stock quantity of the company or business entity at each of a plurality of points in future time, and a time point at which the company or business entity needs to re-stock when the surplus stock quantity is supplied to another company or business entity; and calculate an accommodation quantity and accommodation condition of a part, a partly finished product, or a finished product that is suppliable to another company or business entity.

In order to attain the above-mentioned second object, the supply rule generating device according to the one embodiment of the present invention further includes: search means for allowing a company or a business entity that wishes to receive a supply of a given item from another company or business entity to search for accommodable quantities and accommodation conditions of other companies or business entities; supply request means for receiving a supply request of the company or business entity that wishes to receive a supply of the given item; means for calculating how stock shifts at another company or business entity when the another company or business entity supplies the given item in response to the request from the supply request means; and means for enabling the another company or business entity to agree to the supply request.

### Advantageous Effects of Invention

According to the one embodiment of the present invention, the companies or business entities that carry the same item can accommodate one another with the stock or resources in the event of a steep change in demand.

### BRIEF DESCRIPTION OF DRAWINGS

FIG. 1 is a configuration diagram of a “supply rule generating device” according to an embodiment mode of the present invention.

FIG. 2 is a “goods” flow diagram for illustrating the “supply rule generating device” according to the embodiment mode of the present invention.

FIG. 3 is a hardware configuration example diagram of the “supply rule generating device” according to the embodiment mode of the present invention.

FIG. 4 is an item configuration diagram of items for illustrating the operation of the “supply rule generating device” according to the embodiment mode of the present invention.

FIG. 5 is a diagram for illustrating base information and item supply relations between bases, as an illustration of the operation of the “supply rule generating device” according to the embodiment mode of the present invention.

FIG. 6 is a diagram of the base information for showing the operation of the “supply rule generating device” according to the embodiment mode of the present invention.

FIG. 7 is a diagram of supply path information for showing the operation of the “supply rule generating device” according to the embodiment mode of the present invention.

FIG. 8 is a diagram of production information for showing the operation of the “supply rule generating device” according to the embodiment mode of the present invention.

FIG. 9 is a diagram of stock information for showing the operation of the “supply rule generating device” according to the embodiment mode of the present invention.

FIG. 10 is a diagram of in-progress information for showing the operation of the “supply rule generating device” according to the embodiment mode of the present invention.

FIG. 11 is a diagram of a shipment plan for showing the operation of the “supply rule generating device” according to the embodiment mode of the present invention.

FIG. 12 is a diagram of a rule template for showing the operation of the “supply rule generating device” according to the embodiment mode of the present invention.

FIG. 13 is a diagram for illustrating the flow of processing that is executed by a processing unit to generate a supply rule, as an illustration of the operation of the “supply rule generating device” according to the embodiment mode of the present invention.

FIG. 14 is a diagram of production plan information for showing the operation of the “supply rule generating device” according to the embodiment mode of the present invention.

FIG. 15 is a diagram of stock plan information for showing the operation of the “supply rule generating device” according to the embodiment mode of the present invention.

FIG. 16 is a diagram of transport plan information for showing the operation of the “supply rule generating device” according to the embodiment mode of the present invention.

FIG. 17 is a diagram for illustrating the flow of processing that is executed by the processing unit to calculate a surplus quantity, as an illustration of the operation of the “supply rule generating device” according to the embodiment mode of the present invention.

FIG. 18 is a diagram for illustrating the flow of processing that is executed by the processing unit to calculate an accommodation condition, as an illustration of the operation of the “supply rule generating device” according to the embodiment mode of the present invention.

FIG. 19 is a diagram of supply rule information for showing the operation of the “supply rule generating device” according to the embodiment mode of the present invention.

FIG. 20 is a diagram for illustrating the flow of processing that is executed by the processing unit to execute a supply rule, as an illustration of the operation of the “supply rule generating device” according to the embodiment mode of the present invention.

FIG. 21 is a display example diagram of a display device for showing the operation of the “supply rule generating device” according to the embodiment mode of the present invention.

### DESCRIPTION OF EMBODIMENTS

### First Embodiment

A “supply rule generating device” according to an embodiment mode of the present invention is described below with reference to the drawings.

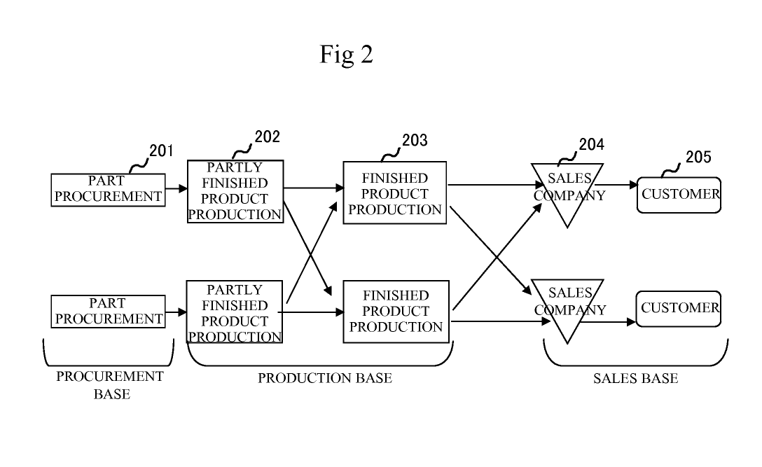

The flow of goods from a production base to a sales base is described first with reference to FIG. 2. At a production base, parts are procured (201), a partly finished product, which has a larger configuration, is produced from the parts (202), a finished product is produced from the partly finished product (203), and the finished product is shipped. The finished product is first delivered to a sales company, which is at a sales base (204), and then delivered to a customer (205). The diagram is versatile and applies also to a product that is not an assembled article, if the part and the partly finished product are read as a raw material and a partly processed product, respectively. For example, in the case of cooking oil, the part is unrefined oil, the partly finished product is refined oil, and the finished product is bottled oil. A finished product may be supplied from a plurality of production bases to a sales base. Means of supply may include a plurality of means different in transport cost and supply time, such as a ship and an airplane, or a regular service and an express service.

Generally speaking, a single company produces a plurality of types of products, and an assembly-type product has a complicate parts configuration, which includes multiple stages. A process-type product may have more than a hundred steps as well, and the actual processing required until a product is ready for circulation is huge. In the description of this embodiment, product types, parts configuration, and the number of steps are simplified in order to make the specifics of the present invention clear.

A “step” in this embodiment may be a facility or a worker, an aggregation of facilities or workers, or may be a factory. In the manufacturing industry in general, labor and the initial cost are often managed in units of an aggregation (organization) of facilities or workers for some reason or other, and the aggregation may be regarded as a “step”.

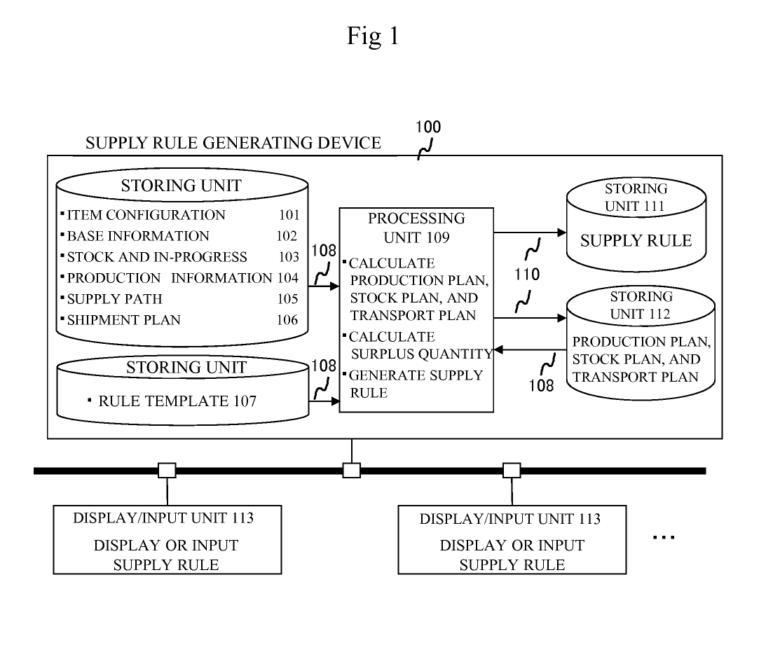

A supply rule generating device 100 in this embodiment is described with reference to FIG. 1. The supply rule generating device includes an item configuration storing unit 101 configured to store an item configuration table of items including products, a base information storing unit 102 configured to store production/storage sites (bases) of items including products, a stock and in-progress storing unit 103 configured to store for each item a stocked quantity and an in-progress quantity on a site-by-site basis, a production information storing unit 104 configured to store for each item a production time on a site-by-site basis, a supply path storing unit 105 configured to store a travel time required to travel from Site (Base) 1 of an item to Site (Base) 2 of the item, a shipment plan storing unit 106 configured to store a shipment quantity of an item for each date and for each site, a rule template storing unit 107, which is referred to when a supply rule is generated, a data input unit 108 configured to store data from the storing units in a memory, a processing unit 109 configured to generate a supply rule by calculating a production plan, a stock plan, a transport plan, and a surplus quantity, a data output unit 110 configured to output the calculated plans and the supply rule from the memory to storing units 111 and 112, the storing unit 111 configured to store the supply rule, and the storing unit 112 configured to store the production plan, the stock plan, and the transport plan. If necessary, the supply rule generating device 100 may include a display/input unit 113, which is used to display/input a supply rule. The display/input unit 113 may be connected to the supply rule generating device by communication means, and corresponds to a terminal at a corporation that uses the supply rule generating device.

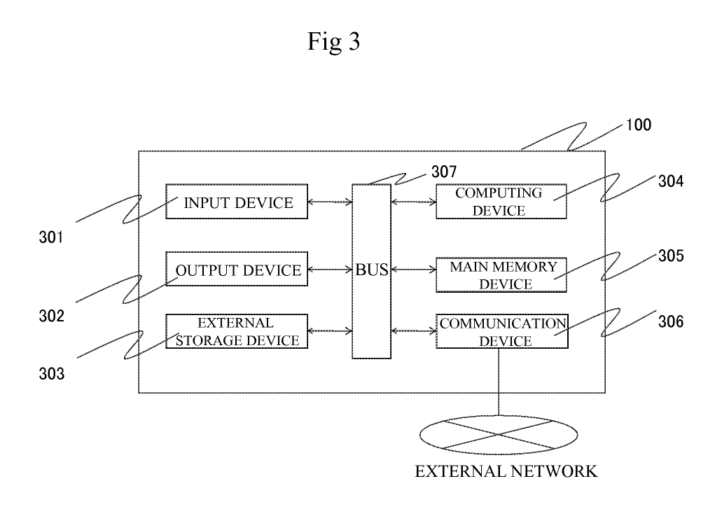

FIG. 3 is a hardware configuration example diagram of the supply rule generating device 100 in this embodiment. The supply rule generating device 100 in this embodiment is a computer such as a personal computer, a work station, or a server machine.

The supply rule generating device 100 includes an input device 301, an output device 302, an external storage device 303, a computing device 304, a main memory device 305, a communication device 306, and a bus 307, which connects the devices to one another.

The input device 301 is a device that receives an input, such as a keyboard and a mouse, or a touch pen, or a pointing device. The output device 302 is a device that displays information, such as a display. The external storage device 303 is a non-volatile storage device such as a hard disk drive or a flash memory. The computing device 304 is a computing device such as a central processing unit (CPU).

The main memory device 305 is a memory device such as a random access memory (RAM). The communication device 306 is a wireless communication device configured to hold wireless communication via an antenna, or a cable communication device configured to hold cable communication via a network cable. The storing units of the supply rule generating device 100 are implemented by the main memory device 305 or external storage device 303 of the supply rule generating device 100.

The input unit, processing unit, and output unit of the supply rule generating device 100 are implemented by a program for causing the computing device 304 of the supply rule generating device 100 to execute processing.

This program is stored in the main memory device 305 or the external storage device 303, loaded onto the main memory device 305 in preparation for execution, and executed by the computing device 304. The supply rule generating device 100 may include the communication device 306 when necessary, and transmit and receive information via the communication device 306. In an example of possible modes of the supply rule generating device 100, the storing units that relate to the production or procurement of parts are installed in a device that is managed by a procurement base, the storing units that relate to the production of a partly finished product or a finished product are installed in a device that are managed by a production base, the storing units that relate to sales are installed in a device that is managed by a sales base, and the processing unit configured to calculate and output results is installed in a device that is managed by an information department.

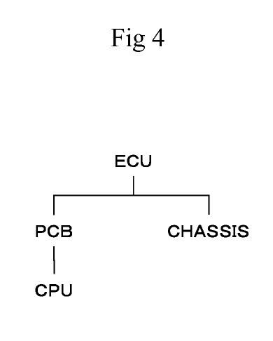

The operation of the supply rule generating device 100 of this embodiment is described next by using concrete examples as the need arises. FIG. 4 is a parts configuration diagram of a product “ECU”. One unit of the product “ECU” is produced with the use of one unit of a partly finished product “PCB” and one unit of a part “chassis”. One unit of the partly finished product “PCB” is produced with the use of one unit of a part “CPU”. The data of FIG. 4 is stored in the item configuration storing unit 101.

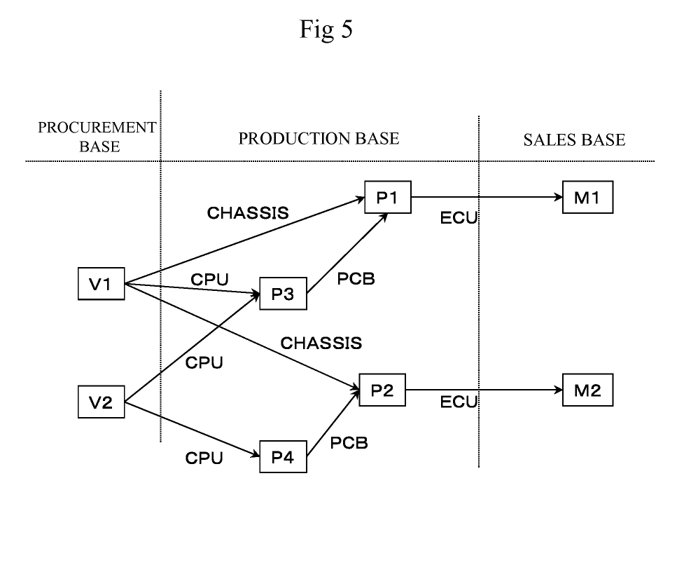

Bases include, as shown in FIG. 5, two ECU sales bases M1 and M2, two ECU production bases P1 and P2, two PCB production bases P3 and P4, and two bases from which the chassis and the CPU are procured (hereinafter referred to as procurement bases), V1 and V2. A supply path between bases is represented by the arrow. The ECU that is supplied to the sales base M1 is produced by procuring the chassis from V1, procuring the CPU from V1 and V2, producing the PCB at P3, and producing the ECU at P1. The ECU that is supplied to the sales base M2 is produced by procuring the chassis from V1, procuring the CPU from V2, producing the PCB at P4, and producing the ECU at P2.

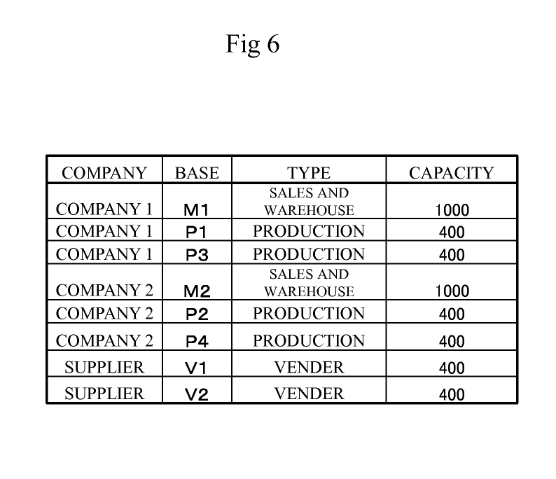

FIG. 6 is a diagram of a base managed by a company, and the type and capacity of the base. For example, Company 1 manages the sales base M1, the production base P1, and a production base P3. The data about companies and bases of FIGS. 5 and 6 is stored in the base information storing unit 102. In the case where the capacity fluctuates from period to period, the capacity may be recorded on a period-by-period basis.

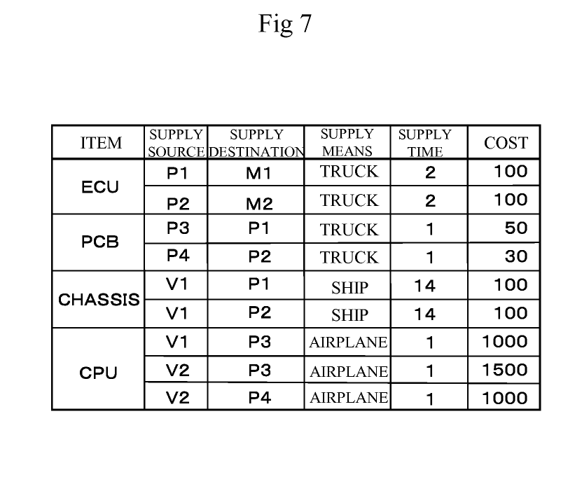

FIG. 7 is a diagram for showing, for each supply path, a supply time (supply lead time) and a cost. For example, data registered in the first row of FIG. 7 indicates that transporting the item ECU by a truck from the base P1, which is the supply source, to the base M1, which is the supply destination, requires two periods and a cost of 100. The data of FIG. 7 is stored in the supply path storing unit 105.

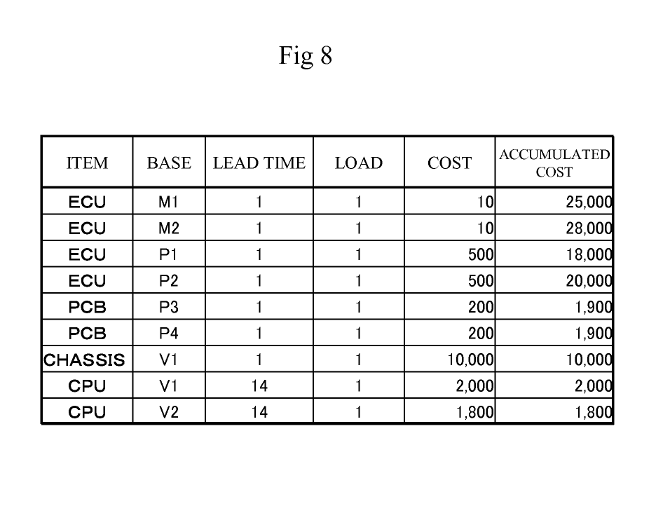

Items handled at the respective bases require load quantities, lead times, and costs shown in FIG. 8 for processing such as production and warehousing. The data of FIG. 8 is stored in the production information storing unit 104.

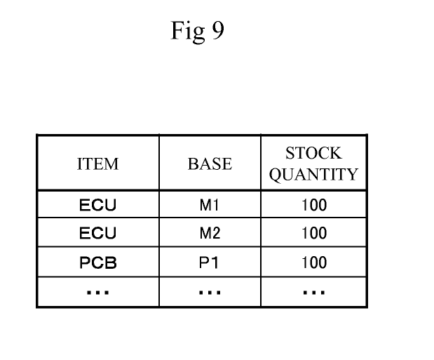

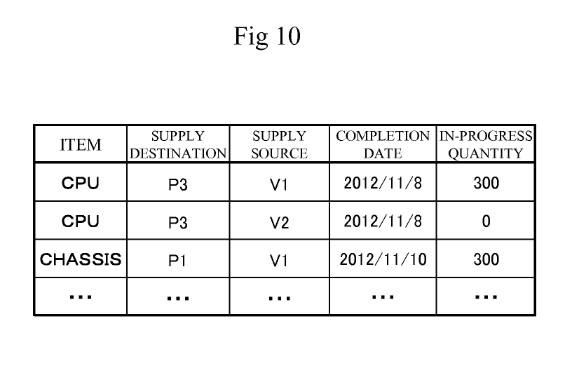

Stock information and in-progress information of items handled at the respective bases are shown in FIG. 9 and FIG. 10, respectively. The stock information and the in-progress information are stored in the stock and in-progress information storing unit 103.

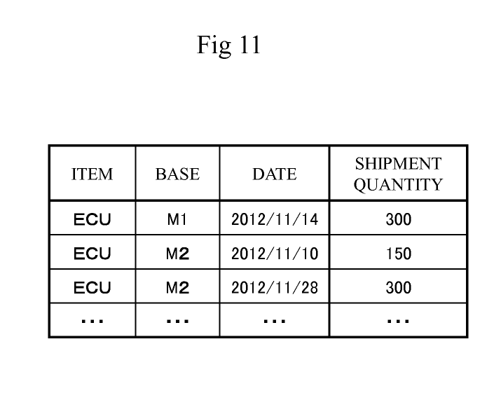

A shipment plan of shipment from the respective bases is shown in FIG. 11. The shipment plan is for registering a period and a quantity in which a product or a part is shipped to other sites than a base that is registered in the base information storing unit 102. The data of FIG. 11 is stored in the shipment plan storing unit 106. The period, which is a day in this embodiment, may be in other units, for example a week, ten days, or a month.

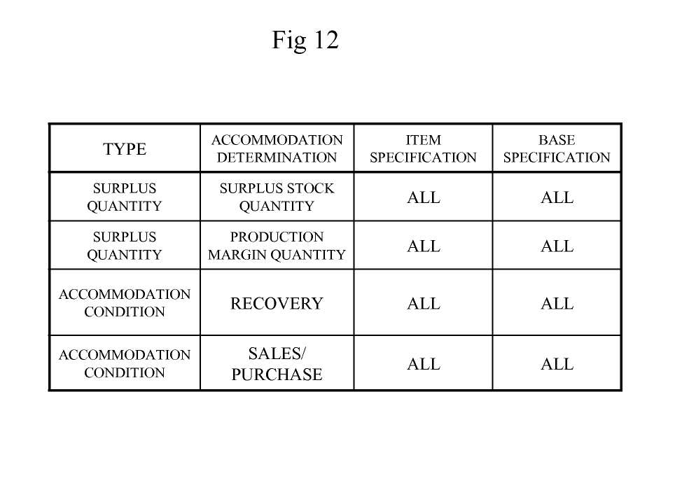

A rule template, which is referred to when a supply rule is generated, is shown in FIG. 12. An item that can be supplied from one base to another and a base that can accommodate another base with an item are set among others. The data of FIG. 12 is stored in the rule template storing unit 107.

The pieces of information described above are stored in the memory by the data input unit 108, used by the processing unit 109 to calculate a production plan, a stock plan, and a transport plan, and to generate a supply rule. The plans and the supply rule are output from the memory to the relevant storing units by the data output unit 110.

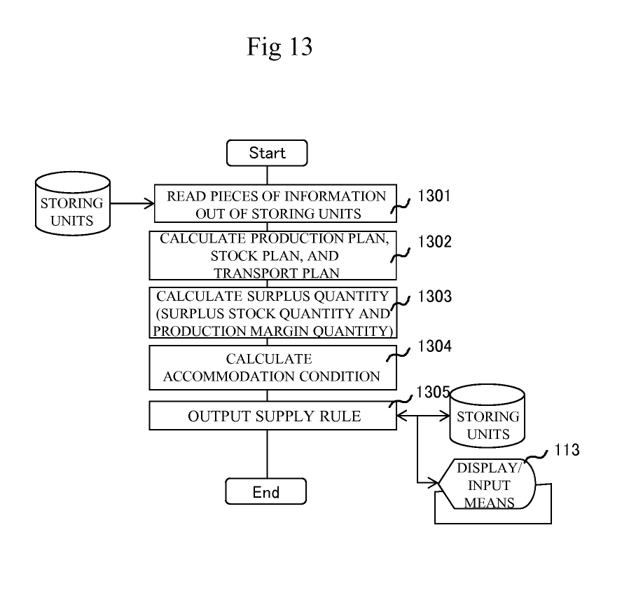

The data input unit 108, the processing unit 109, the data output unit 110, and the display/input means 113 execute processing with the use of the CPU and the memory in steps illustrated in FIG. 13.

The processing in the respective steps is described below.

<Step 1301>

The data input unit 108 reads the input information 101 to the input information 107, which are necessary for the calculation, out of the storing units onto the memory.

<Step 1302>

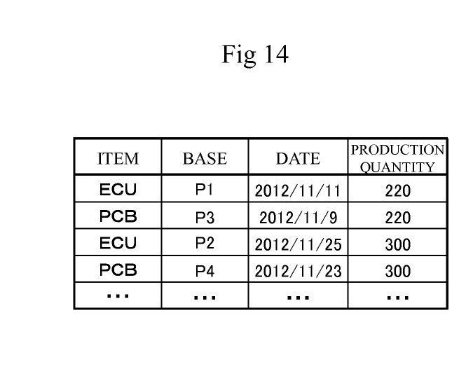

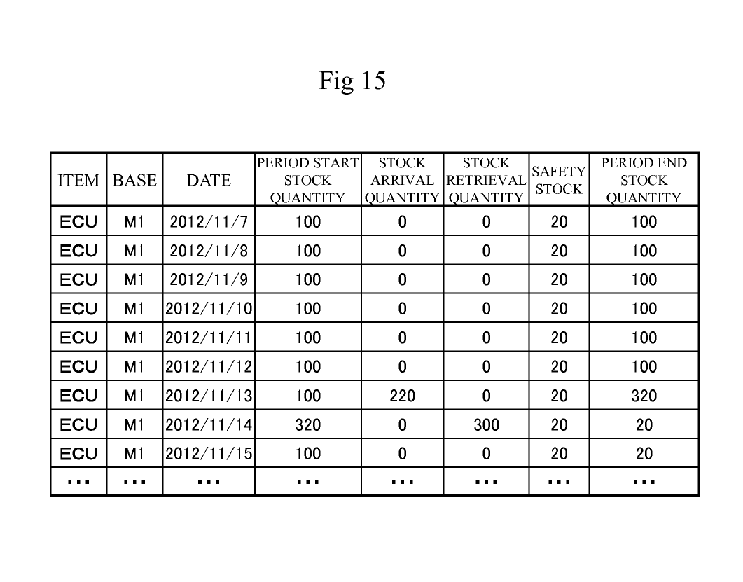

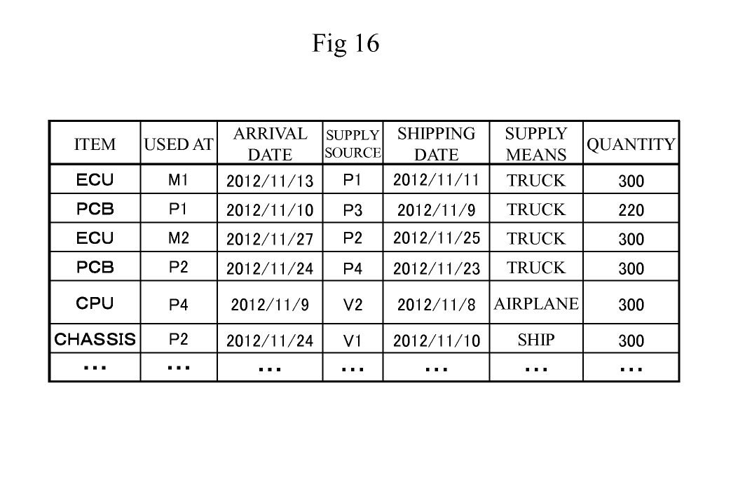

For each base, a production plan, a stock plan, and a transport plan for transportation from the base to another base are planned based on the shipment plan read out of the shipment plan storing unit. Specifically, for each item registered in the shipment plan, items to be produced at the respective production bases in order to ship the registered item from a specified base at a specified date in a specified shipment quantity are calculated, as well as dates and production quantities of the production, item-by-item transport quantities in transportation between bases, and stock arrival/retrieval transitions at the respective bases. The calculation takes into account constraints such as a lead time and stock quantity required for production and transportation. There are many known algorithms for calculating a production plan and a transport plan, and the present invention is not limited to a particular method of calculating a production plan or a transportation plan. An example of a system that uses material requirements planning (MRP) is found in Japanese Patent Laid-open Publication No. 2000-79542, and an example of a system that uses linear planning or mixed integer programming is found in Japanese Patent Laid-open Publication No. 2010-55382. The processing unit may include a plurality of algorithms out of those or other calculation algorithms so that an algorithm selected for each company separately is used in the calculation. An example of the production plan is shown in FIG. 14. An example of the stock plan is shown in FIG. 15. An example of the base-to-base transport plan is shown in FIG. 16. A safety stock quantity in the stock plan is obtained by a calculation equation or as a fixed value. The safety stock quantity that is obtained by a calculation equation may be calculated by the processing unit with the use of one of the calculation algorithms. The safety stock quantity that is a fixed value may be kept in one of the storing units to be read by the data input unit 108.

<Step 1303>

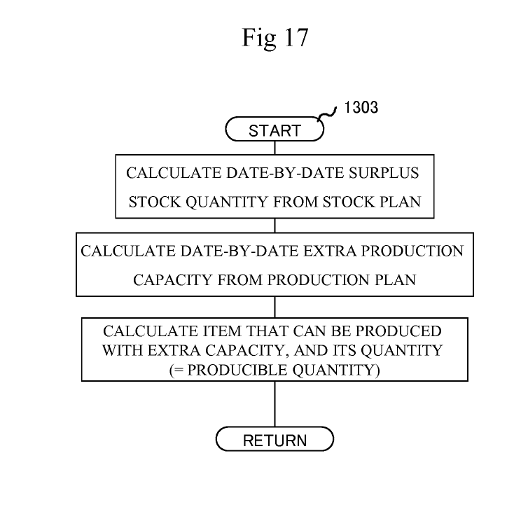

A surplus stock quantity and a production margin quantity are calculated as a surplus quantity from the production plan and stock plan calculated in Step 1302. An example of how the surplus quantity is calculated is described with reference to FIG. 17.

First, the surplus stock quantity is obtained by subtracting the safety stock from a period end stock quantity in the stock plan. The surplus stock quantity is calculated for each item and each base that are specified in the rule template on a period-by-period basis. In the example of FIG. 15, the surplus stock quantity is 80 between 11/7 and 11/12, 300 on 11/13, and 0 on 11/14 and 11/15.

Next, an extra production capacity is calculated from the production plan for a production base out of bases specified as subjects of the production margin quantity calculation in the rule template. Specifically, the extra production capacity is calculated by subtracting the production man-hour from the production capacity. While the production man-hour can be calculated by any method, the production man-hour in this embodiment is the product of a production quantity in the production plan and a load in the production information. For example, the extra capacity of the base P1 on 11/11 is calculated as 180 by 400−(220×1).

An item and a quantity in which the item can be produced with the use of the extra production capacity are calculated next. In the example of the production man-hour calculation method given above, the quotient of the extra production capacity of P1 divided by the ECU load is calculated for each item that can be produced at P1 (while the ECU is the only item that can be produced at P1 in this embodiment, generally a plurality of items can be produced at one base). The ECU production margin quantity of the base P1 on 11/11 is 180÷1=180. Items for which this calculation is to be performed are specified by item specification in a row of the rule template where “production margin quantity” is registered. The production margin quantity that is calculated by the method described above is an accommodation quantity in which an item can be supplied from one company to another company.

The calculation method given in this step is merely an example, and other calculation methods may be employed instead.

<Step 1304>

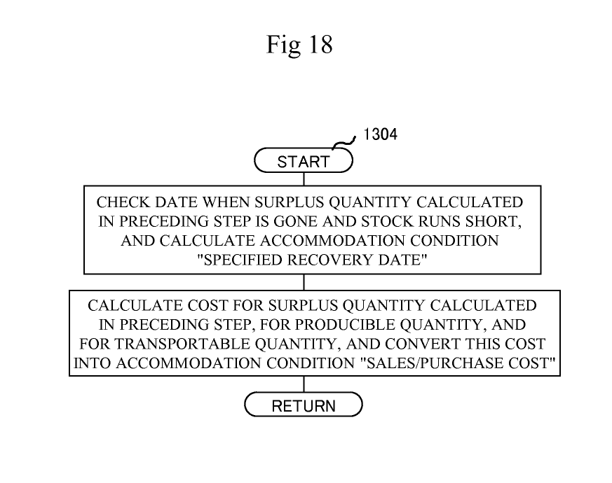

An accommodation condition is calculated for the surplus quantity calculated in Step 1303. Details of this step are illustrated in FIG. 18. First, a date when the surplus stock quantity calculated in Step 1303 is gone and stock is in shortage is identified. In the example of FIG. 15, the surplus stock quantity “80” between 11/7 and 11/12 becomes “−80” on 11/14, and the surplus stock quantity “300” on 11/13 becomes “−300” on 11/14.

A specified recovery date is calculated by adding safety days to 11/14. For example, when a single day is set as the safety days, 11/13 is calculated as the specified recovery date. The safety days may be read out of one of the storing units, or may be written in the program of the processing unit.

Next, a cost is calculated for the surplus quantity calculated in Step 1303. The cost of the surplus quantity is an accumulation of item-by-item costs and base-by-base costs. No particular method of cost calculation is specified here. The cost of the surplus quantity may be calculated by adding up standard costs set to the respective items, or may be calculated by obtaining constituent parts and supply routes from the item configuration and adding up a parts cost, a production costs, and transport costs. This embodiment describes an example in which the accumulated cost is calculated by some method and registered in the production information of FIG. 8. For example, the per-unit accumulated cost is 25,000 for the surplus quantity of the item ECU at the base M1. An amount obtained by adding a cost of accommodating processing to this cost is a sales/purchase cost. When the accommodation processing cost is 3%, for example, the sales/purchase cost is 25,750. The accommodation processing cost may be defined in percentage as described above, or by a mathematical expression or a program, or may be defined in the form of a numerical value. The accommodation processing cost may be read out of one of the storing units or may be written in the program of the processing unit. The calculated accommodation processing cost is presented as an accommodation condition to a company that is asked to accommodate another company with its surplus stock, and the company that wishes to be accommodated can be supplied with the surplus stock by paying the cost.

<Step 1305>

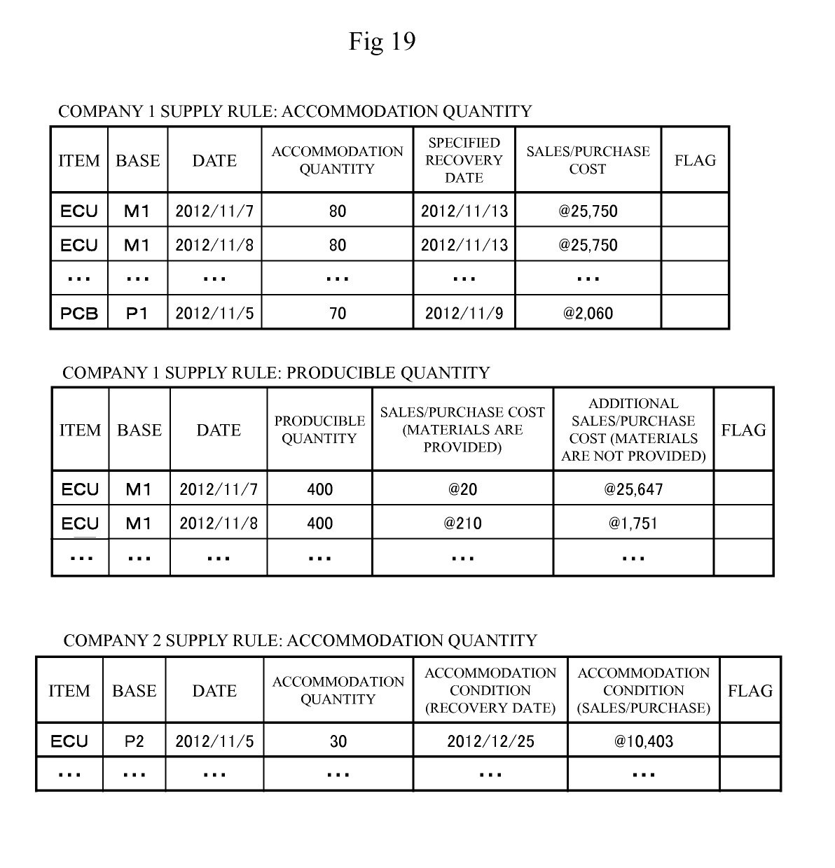

The surplus quantity calculated in Step 1303 and the accommodation condition calculated in Step 1304 are output as a “supply rule” to the supply rule storing unit 111 on a company-by-company basis. An example of the supply rule is shown in FIG. 19. The rule may be displayed on the display unit 113 of each company to be modified via the input unit.

Shown in “Company 1 supply rule: accommodation quantity” are an accommodation quantity and an accommodation condition that are calculated for Company 1 in the steps described above. The accommodation quantity is a quantity in which Company 1 can accommodate another company with its surplus stock. The specified recovery date is a date when Company 1's stock is gone in the case where Company 1 supplies its stock in the accommodation quantity to another company, and Company 1 needs to recover the stock quantity by the specified recovery date. Company 1 decides to accommodate another company with its stock if it is estimated that re-stocking by the specified recovery date is feasible.

Shown in “Company 1 supply rule: producible quantity” are a producible quantity in which Company 1 can produce a product or a part with the use of the extra capacity calculated in the manner described above, and a cost of the production. Company 1 can supply a product or a part in the producible quantity in addition to the accommodation quantity to another company. Company 1 can re-stock by producing a product or a part by itself after supplying its surplus stock to another company as long as the supplied quantity is within the producible quantity.

By calculating a supply rule for each company in the manner described above, accommodation quantity information and producible quantity information of the respective companies are accumulated in the storing unit 111.

The processing has been described in detail by taking stock and production capacity as an example of the supply rule. While a company can accommodate another company with its stock in the surplus quantity, which is the sum of the surplus stock quantity and the production margin quantity, it is not always necessary to calculate both of the surplus stock quantity and the production margin quantity. For instance, only the surplus stock quantity may be calculated in order to supply in the calculated surplus stock quantity. Other than stock, companies may accommodate one another with a production jig, a storage space, and an unoccupied space in a transport container. A production jig can be added to the surplus stock quantity, and a storage space and an unoccupied space in a transport container can be added to the storing units and the processing unit by applying the production margin quantity processing step.

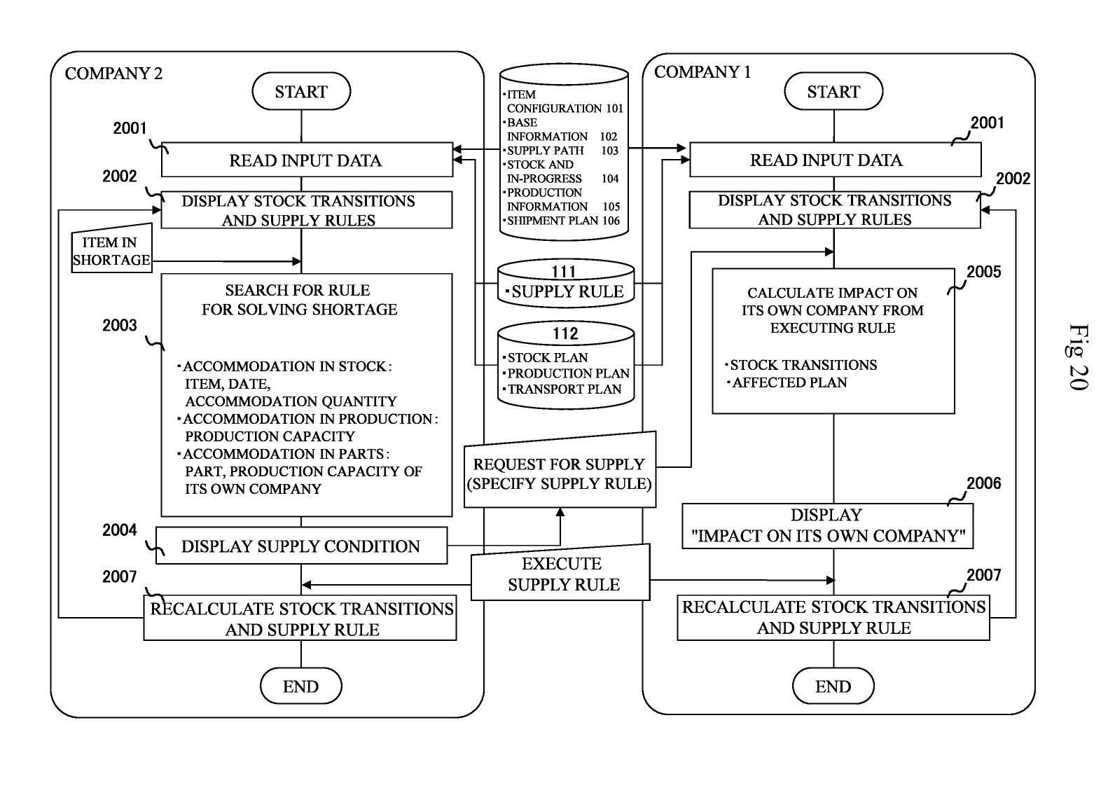

Described next is a method of supplying stock, or a product or apart in the production margin quantity, from one company to another company with the use of the “supply rule”. This method, also, is implemented by the data input unit 108, the processing unit 109, the data output unit 110, and the display/input means 113 by executing processing with the use of the CPU and the memory in steps illustrated in FIG. 20. In the processing flow of FIG. 20, Company 2 asks for accommodation and Company 1 agrees to accommodate Company 2 with stock or a product or a part. However, this is not to limit the number of companies.

<Step 2001>

The data input unit 108 reads the input information 101 to the input information 106, the input information 111, and the input information 112, which are necessary for the calculation, out of the storing units onto the memory.

<Step 2002>

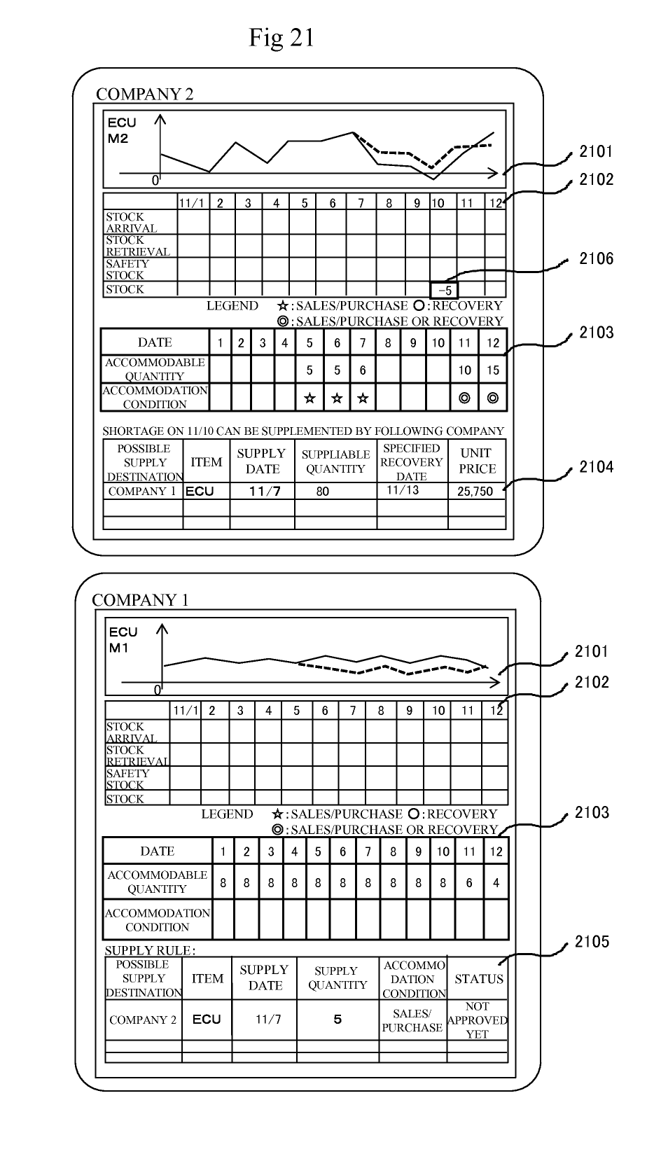

The display unit displays stock transitions and supply rules of the companies. A display example is shown in FIG. 21. A broken line graph 2101 indicates the period end stock quantity, and a table 2102 is a stock plan table. While the graph and the table are displayed on an item-by-item basis and on a base-by-base basis in the example of FIG. 21, pieces of information about a plurality of items or a plurality of bases may be combined to be displayed. A place 2106 where stock is in shortage is highlighted or otherwise displayed in a manner that draws the attention of a person operating the terminal.

Displayed in 2103 is the supply rule of its own company. In the screen example, the surplus quantity is displayed in a row “accommodable quantity”. Ina row “accommodation condition”, a mark representing “sales/purchase or supply recovery” may be displayed so that the accommodation condition is understood macroscopically, or the accommodation condition may be displayed in a pop-up via input means such as a mouse. The subsequent steps are described by taking as an example a case where Company 1 accommodates Company 2 with an item the stock of which has run short on 11/10. Company 2 specifies the item that has run short and executes Step 2003.

<Step 2003>

A rule that can be used to supplement a shortage of 5 of the item ECU at the base M2 by 11/10 is extracted from among supply rules. First, a shortage of 5 of the item ECU at the base M2 is shorted down to parts (necessary days and a necessary quantity are calculated for each parts configuration) by the planning algorithm used in Step 1302. At the same time, supply rules applicable to this item, base, date, and quantity are searched for and temporarily saved in the memory. Supply rules on which the search is conducted include those of its own company. This enables the company to check, if the company accommodates another company with a part, whether or not the company has a substitute part or a capacity to produce the part.

<Step 2004>

The supply rules extracted in Step 2003 are displayed in a window 2104 of FIG. 21. A rule to be executed is selected from the list via the input means. Then, the graph 2101 that indicates how stock shifts when the rule is executed is displayed in a dotted line, and numerical values thereof are displayed in 2102. A plurality of rules instead of one may be selected. A quantity presented in the selected rule may be reduced. A person who is in charge of the planning specifies a supply rule and executes “supply request”. The supply request is notified to the display means of each relevant company. The display means may display a pop-up on the screen of FIG. 21, or may notify a portable terminal or the like via the communication device 306. In the next step, the processing is described by taking as an example a case where Company 1 receives the request.

<Step 2005>

The display means of Company 1, which has received the request, displays the supply rule that is waiting for approval as shown in 2105 of FIG. 21. This area may also display already approved rules. When a supply rule is selected from the list, the degree of impact on its own company that is incurred by executing the rule is calculated. Specifically, the item configuration and the supply path, and the planning algorithm of Step 1302 are used to re-reserve stock. Although the premise of supply rules, which use the surplus quantity, does not exclude reservation, there is a chance of error if the timing of data coordination is off, and rechecking that there is no impact is more natural in the course of operation. The processing of this step is therefore preferred to reservation. In the case where a supply rule about an item that the company clearly has no objection to supplying, such as an item for which no use is planned, can be specified as a supply rule that is automatically approved, a flag indicating the fact may be attached to the supply rule so that the processing proceeds to Step 2007 by skipping Step 2005 and Step 2006.

<Step 2006>

The graph 2101 of stock transitions calculated in Step 2005 is displayed in a dotted line and numerical values thereof are displayed in 2102. A plurality of rules instead of one may be selected. The person who is in charge of the planning checks the impact on his/her own company and chooses whether to approve the rule. After the rule is approved, Step 2007 is executed.

<Step 2007>

The approved supply rule is output to the supply rule storing unit 111, with a flag for identifying the supply rule as an approved rule attached thereto. The supply rule is then added as in-progress (stock arrival/retrieval schedule), and Steps 1302 to 1305 are executed. The recalculated stock plan, production plan, and transport plan, and the supply rule are used to execute Step 2002. The display means of Company 1 and the display means of Company 2 display a message to the effect that the rule has been applied. The entire processing of FIG. 20 is ended once the item shortage is solved or rule approving is executed. The approved supply rule is forwarded to means for executing accommodation (an example of which is not given in this embodiment).

As described above, generating a supply rule for accommodation for each company separately enables the companies, including ones that have difficulties in holding direct negotiation due to time difference, to find out whether the companies can accommodate one another with a product or a part in the event of large fluctuations in demand or supply.

In addition, the supply system can be established quickly by supplying surplus stock or stock that is temporarily available for accommodation, or a product or a part in the production margin quantity from one company to another. This also helps to reduce the surplus quantity.

Further, when an item is out of stock, presenting a supply rule by taking into account the parts configuration of the item increases the number of accommodation methods to choose from, and a company can select a method that is small in cost and risk from the increased options.

The present invention is not limited to the embodiment described above and covers various modification examples. For instance, the embodiment described above is a detailed description written for an easy understanding of the present invention, and the present invention is not necessarily limited to a configuration that includes all of the described components. The configuration of one embodiment may partially be replaced by the configuration of another embodiment. The configuration of one embodiment may be joined by the configuration of another embodiment. In each embodiment, a part of the configuration of the embodiment may have another configuration added thereto or removed therefrom, or may be replaced by another configuration.

Some of or all of the configurations, functions, processing units, processing means, and the like described above may be implemented by hardware by, for example, designing those as an integrated circuit. The configurations, functions, and the like described above may be implemented by software through a processor's interpretation and execution of programs for implementing the respective functions. The programs for implementing the functions and information such as tables and files can be put in a memory, in a recording device such as a hard disk or a solid state drive (SSD), or in a storage medium such as an IC card, an SD card, or a DVD.

Control lines or information lines considered necessary for description are illustrated, and not all control lines and information lines are necessarily illustrated. It may be considered that almost all configurations are actually mutually connected to each other.

### REFERENCE SIGNS LIST

100: supply rule generating device
101: item configuration storing unit
102: base information storing unit
103: stock and in-progress storing unit
104: production information storing unit
105: supply path storing unit
106: shipment plan storing unit
107: rule template storing unit
108: data input unit
109: processing unit
110: data output unit
111: supply rule storing unit
112: production plan, stock plan, and transport plan
113: display/input means

1. A supply rule generating device, comprising a storing unit and a processing unit, the supply rule generating device being configured to calculate a supply rule, which is a condition for enabling two or more companies or business entities that procure or supply the same part or same product to accommodate one another with a part, a partly finished product, or a finished product,
wherein the storing unit comprises:
an item configuration storing unit configured to store a configuration table of items including parts, partly finished products, or finished products;
a stock and in-progress storing unit configured to store, for each item, a stock quantity and an in-progress quantity on a site-by-site basis;
a product information storing unit configured to store, for each item, a production time and a cost on a site-by-site basis; and
a shipment plan storing unit configured to store a shipment quantity of a product on a date-by-date basis and on a site-by-site basis, and
wherein the processing unit is configured to:
calculate a production plan and a stock plan for each of the two or more companies or business entities so that the shipment quantity stored in the shipment plan storing unit is fulfilled, based on the information stored in the stock and in-progress storing unit and the information stored in the production information storing unit;
calculate, from the calculated production plan and stock plan, a surplus stock quantity of the company or business entity at each of a plurality of points in future time, and a time point at which the company or business entity needs to re-stock when the surplus stock quantity is supplied to another company or business entity; and
calculate an accommodation quantity and accommodation condition of a part, a partly finished product, or a finished product that is suppliable to another company or business entity.

2. A supply rule generating device according to claim 1, wherein the surplus stock quantity at each of the plurality of points in time is calculated as a difference between a period end stock quantity and safety stock.

3. A supply rule generating device according to claim 1, wherein the processing unit calculates a production margin quantity from the calculated production plan, and adds the production margin quantity to the surplus stock quantity to obtain the accommodation quantity in which a part, a partly finished product, or a finished product is suppliable to another company or business entity.

4. A supply rule generating device according to claim 1, wherein the processing unit calculates a cost for supplying a part, a partly finished product, or a finished product in the surplus stock quantity or in the production margin quantity, and outputs the cost along with the accommodation quantity as the accommodation condition.

5. A supply rule generating device according to claim 1,
wherein the storing unit stores a rule template specifying an item and a base for which the surplus stock quantity and the accommodation condition are calculated, and
wherein the processing unit calculates the surplus stock quantity and accommodation condition of the item specified in the rule template at the base specified in the rule template.

6. A supply rule generating device according to claim 1, further comprising:
search means for allowing a company or a business entity that wishes to receive a supply of a given item from another company or business entity to search for accommodable quantities and accommodation conditions of other companies or business entities;
supply request means for receiving a supply request of the company or business entity that wishes to receive a supply of the given item;
means for calculating how stock shifts at another company or business entity when the another company or business entity supplies the given item in response to the request from the supply request means; and
means for enabling the another company or business entity to agree to the supply request.

7. A supply rule generating device according to claim 6, wherein the supply rule generating device is connected to a terminal of each of the two or more companies or business entities by communication means.

8. A supply rule generating program, comprising a storing unit and a processing unit, the supply rule generating program being configured to calculate a supply rule, which is a condition for enabling two or more companies or business entities that procure or supply the same part or same product to accommodate one another with a part, a partly finished product, or a finished product,
the supply rule generating program causing a computer to execute the procedures of:
storing a configuration table of items including parts, partly finished products, or finished products in an item configuration storing unit;
storing, for each item, a stock quantity and an in-progress quantity on a site-by-site basis in a stock and in-progress storing unit;
storing, for each item, a production time and a cost on a site-by-site basis in a product information storing unit;
storing a shipment quantity of a product on a date-by-date basis and on a site-by-site basis in a shipment plan storing unit;
calculating a production plan and a stock plan for each of the two or more companies or the business entities so that the shipment quantity stored in the shipment plan storing unit is fulfilled, based on the information stored in the stock and in-progress storing unit and the information stored in the production information storing unit; and
calculating, from the calculated production plan and stock plan, a surplus stock quantity of the company or business entity at each of a plurality of points in future time, and a time point at which the company or business entity needs to re-stock when the surplus stock quantity is supplied to another company or business entity, and calculating an accommodation quantity and accommodation condition of a part, a partly finished product, or a finished product that is suppliable to another company or business entity.

9. A supply rule generating program according to claim 8, wherein the surplus stock quantity at each of the plurality of points in time is calculated as a difference between a period end stock quantity and safety stock.

10. A supply rule generating program according to claim 8, further comprising a procedure of calculating a production margin quantity from the calculated production plan, and adding the production margin quantity to the surplus stock quantity to obtain the accommodation quantity in which a part, a partly finished product, or a finished product is suppliable to another company or business entity.

11. A supply rule generating program according to claim 8, further comprising a procedure of calculating a cost for supplying a part, a partly finished product, or a finished product in the surplus stock quantity or in the production margin quantity, and outputting the cost along with the accommodation quantity as the accommodation condition.

12. A supply rule generating program according to claim 8, further comprising a procedure of storing a rule template specifying an item and a base for which the surplus stock quantity and the accommodation condition are calculated,
wherein the surplus stock quantity and accommodation condition of the item specified in the rule template at the base specified in the rule template is calculated.

13. A supply rule generating program according to claim 8, further comprising:
a procedure of allowing a company or a business entity that wishes to receive a supply of a given item from another company or business entity to search for accommodable quantities and accommodation conditions of other companies or business entities;
supply request means for receiving a supply request of the company or business entity that wishes to receive a supply of the given item;
a procedure of calculating how stock shifts at another company or business entity when the another company or business entity supplies the given item in response to the request from the supply request means; and
a procedure of enabling the another company or business entity to agree to the supply request.

14. A computer-readable storage medium having stored thereon the supply rule generating program of claim 8.
